(19) United States
(12) Patent Application Publication
(10) Pub. No.: US 2026/0143102 A1
(43) Pub. Date: May 21, 2026

(54) APPARATUS FOR CHECKING AN ADJUSTMENT STATE OF AN IMAGE SENSOR, AND METHOD FOR CHECKING AN ADJUSTMENT STATE OF AN IMAGE SENSOR

(71) Applicant: TRIOPTICS GmbH, Wedel (DE)

(72) Inventor: Stefan KREY, Wedel (DE)

(73) Assignee: TRIOPTICS GmbH, Wedel (DE)

(21) Appl. No.: 18/705,831

(22) PCT Filed: Oct. 25, 2022
(86) PCT No.: PCT/EP2022/079694

§ 371 Date: Apr. 29, 2024

(30) Foreign Application Priority Data
Oct. 29, 2021 (DE) 10 2021 128 335.3

(51) Int. Cl. H04N 17/00; H04N 23/55

(52) U.S. Cl. CPC H04N 17/002; H04N 23/55

(57) ABSTRACT

The invention relates to an apparatus (200) for checking an adjustment state of an image sensor (120) of a camera module (115), the apparatus (200) having the following features:
a first optical device (205) having a first optical element (220) which can be illuminated by a first light source (210) and can be moved along a first optical axis (215);
a second optical device (235) having a second optical element (250) which can be illuminated by a second light source (240) and can be moved along a second optical axis (245), the second optical device (235) being positioned at a distance from the first optical device (205) and the first optical axis having a point of intersection (260) with the second optical axis (245), it being possible to position the camera module (115) to be checked in a region of the point of intersection (260); and
an evaluation device (270), which is designed to read in position information (275) that represents a position, detected at a specific time, of the first and second optical elements (220, 250), and to read in an image signal (285) that represents image information detected by the image sensor (120) at said specific time, the evaluation device being designed to use the image signal (285) and/or the position signal (275) to assign image information to each detected position in order to determine the adjustment state of the camera module (115).

The present approach relates to an apparatus for checking an adjustment state of an image sensor, and to a method for checking an adjustment state of an image sensor.

Various approaches for active alignment of camera modules are known from the prior art. In this case, Active Alignment is implemented within the scope of a production process. After completion of the production process, it is necessary to check the quality of the alignment of the camera system. The alignment can be negatively influenced, for example by production steps such as the uneven curing of the adhesive with which the optics and the sensor are fixed to one another, but also by mechanical influences or temperature effects. In many cases, finished camera modules are checked using simple test image structures, and it is determined whether they fulfill the defined sharpness criteria.

### DISCLOSURE OF THE INVENTION

Against this background, the present approach presents an apparatus for checking an adjustment state of an image sensor, and a method for checking an adjustment state of an image sensor, according to the main claims. Advantageous embodiments result from the respective dependent claims and the following description.

By means of the apparatus presented here and the presented method, checking of an adjustment state of the image sensor of a camera with respect to the associated optics can advantageously be improved. In this case, the degree of mechanical tilting or sensor misalignment, which can lead to a drop in sharpness, can be determined quantitatively.

An apparatus for checking an adjustment state of an image sensor of a camera module is presented, wherein the apparatus has the following features:

a first optical device having a first optical element that can be illuminated by a first light source and can be moved along a first optical axis,
a second optical device having a second optical element that can be illuminated by a second light source and can be moved along a second optical axis, the second optical device being arranged (for example radially) at a distance from the first optical device, and the first optical axis having an intersection point with the second optical axis, the camera module to be checked being able to be arranged in a region of the intersection point, and
an evaluation device which is designed to read in position information which represents a position of the first and the second optical element detected at a specific point in time, and to read in an image signal which represents an item of image information detected by the image sensor at the specific point in time, the evaluation device being designed to assign an item of image information to each detected position using the image signal and additionally or alternatively to the position information, in order to determine the alignment state of the camera module.

For example, the apparatus presented here can be used to check the image sensor of a camera with respect to the associated optics, for example at the end of the production process of the camera. An important measurement parameter during the checking of the camera alignment following the assembly can be the degree of tilting between an image plane of the optics and a sensor plane, which affects the sharpness or contrast distribution in the image field. In this case, the camera module to be checked, which can be formed, for example, of optics and sensor, can be illuminated by means of the optical devices, for example with collimated light. The illumination can take place both at the axial position, in parallel with the optical axis of the test object, and at one or more off-axis positions. In order to advantageously obtain a quantitative statement about the degree of mechanical sensor tilting or defocussing in a fully assembled camera system, the apparatus presented here can use focusable optical devices which can also be referred to as collimators. One optical device is already sufficient for purely axial focusing. If one wishes to determine the tilting of the image plane in one direction, an off-axis optical device is additionally required. At least one further, off-axis optical device is required, which may not be arranged along a line with the axial optical device and the first off-axis optical device, in order to determine the tilting of the image plane of the optical system to be checked, in two directions. In order to increase the number of measuring positions and to make an additional statement about the curvature of the image plane, further, off-axis optical devices can be added. The determination of the spatial position of the image plane of the test object represents an advantageous application of the invention. For improved readability, reference is made in the further course of this description to a first and a second optical device. By displacing or moving the optical elements within the optical devices, a test object can be imaged at different apparent object distances. For this purpose, the optical elements can be designed for example as a reticle plate (reticle) which can be moved along the optical axis of the optical device in question, so that it is possible to carry out a focusing run.

In this case, approximately the following relationship between the movement ΔZ_{OE} of the optical element within the optical device and the z-position of the measurement point in the image plane of the camera system Δz_{K} to be checked can be taken into account:

$$Δ {z}_{K} = {f}_{{K}^{2}} / {f}_{{OE}^{2}} \times Δ {z}_{OE}$$

where fₖ is the focal length of the optics of the camera system to be checked, and for is the focal length of the optical element.

It is important here to have a unique relationship between the z-position, which can be defined by the position of the reticle plate in the optical device, and for example a respective value of the image contrast, for example as a modulation transfer function (MTF value) of the projected individual image. This relationship can advantageously be ensured by means of the apparatus presented here in a rapid and highly accurate manner. In this case, the apparatus is designed in such a way that the image information acquired from the test object, i.e., for example, the comparison that can be written by the MTF value, between the detail contrast at edges of an object and the detail contrast of an image representation of the same object, can be processed. For this purpose, the apparatus comprises the evaluation device which is designed to assign an item of image information, for example an MTF value, to each detected item of position information of the optical elements, using the image signal and additionally or alternatively to the position signal, in order to determine the adjustment state of the camera module. As a result, synchronization of the recorded image information to the position of the optical elements in the optical devices can advantageously be achieved.

According to one embodiment, the apparatus can comprise an image capture circuit which can be designed to control or read out the image sensor depending on the position of the optical elements, and which can be designed to provide the image signal. For example, the image capture circuit, which can also be referred to as a frame grabber, can be an electronic circuit for digitizing analog image signals or also for reading out digital image data. In this case, the image capture circuit can additionally or alternatively be designed to connect the camera module to a wide variety of systems. The apparatus can thus be designed, for example, in such a way that the image information captured by the image sensor can be processed using the image capture circuit. In this case, the image capture circuit can be designed, for example, to provide the image signal to the evaluation device via an interface. Additionally or alternatively, the image capture circuit can, for example, be connected or connectable, for signal transmission, to a control device for controlling the optical devices. In other words, the image capture circuit (frame grabber) serves for electronic further processing or forwarding of the image information detected by the sensor.

According to a further embodiment, the apparatus can comprise a control device for controlling the first optical element and the second optical element. In this case, the control device can be designed to provide the position information. For example, all optical devices, more precisely their motor controllers or their movement drives, can be electronically connected to the control unit in parallel. Each optical device can, in turn, have a position encoder, by means of which the exact position of the respective optical element can be determinable. Advantageously, a movement of the individual optical elements by the control device can be optimally matched to the other optical elements. In addition, the control device can be designed to provide the respective positions using the position information. A synchronization of position and image information can advantageously be optimized thereby.

According to a further embodiment, the apparatus can be designed to arrange the first and the second optical element at the specified point in time in such a way that the intermediate images of the optical elements are located in an identical plane (intermediate image plane). These intermediate images are imaged into the image plane of the optical system to be checked. For example, the first optical element of the first optical device can be movable from a first starting position to a first end position. Correspondingly, the second optical element of the second optical device can be movable from a second starting position to a second end position. In this case, the intermediate images of the optical elements move from a first, common, apparent object plane into a second, common, apparent object plane. The first, apparent object plane correlates with the first and second starting positions, and the second, apparent object plane with the first and second end positions. In this case, can be possible for a variable number of predefined further object planes to be traversed between the first object plane and the second object plane. Of course, this relationship also applies to all conceivable planes along the trajectory of the optical elements. In this case, the speed profiles of the first optical element and of the second optical element can be matched to one another in such a way that the intermediate images of all optical elements can always be arranged at the same time in the previously defined object planes. A trajectory along which the optical elements can be displaced or moved can thus advantageously be specified.

According to a further embodiment, the apparatus can comprise a third optical device having a third optical element that can be illuminated by a third light source and can be moved along a third optical axis. In this case, the third optical device can be arranged (for example radially) at a distance from the first and second optical devices, and the third optical axis can have an intersection point with the first and second optical axes, it being possible for the camera module to be checked to be able to be arranged in a region of the intersection point. For example, the illumination of the optical elements can take place both at the axial position of the first optical device, in parallel with the optical axis of the test object, and at a plurality of off-axis positions. Ideally, the three optical elements are not arranged in one plane, so that the image points projected in the camera module span an image plane, the angular position of which can be determined. In this case, a contrast (MTF) value for a fixed spatial frequency at each of the three field positions can be determined at each z-position of the optical elements. The result of the measurement can be the focusing curve, a representation of the image contrast as a function of the z-position. The degree of tilting of the image plane relative to the sensor plane can advantageously be concluded from the position of the maxima of the three curves along the z-direction, and a defocussing can also be optimally determined. In the case of camera systems that are not yet permanently installed, a Best Focus Position can now be determined using an active alignment between the optics and the sensor.

The use of three optical elements which do not have their optical axes in one plane is particularly advantageous in order to determine the tilting of the image plane of a camera module. Further optical elements can be used to specify the determination and to obtain statements regarding the image field curvature of the test object.

In addition, a method for checking an adjustment state of an image sensor of a camera module (for example using a variant of an apparatus presented here) is presented, the method comprising the following steps:
moving a first optical element, that can be illuminated by a first light source, along a first optical axis of a first optical device, the first optical axis substantially corresponding to an optical axis of the camera module to be checked, and moving a second optical element, that can be illuminated by a second light source, along a second optical axis of a second optical device, the second optical device being arranged (for example radially) at a distance from the first optical device, and the first optical axis having an intersection point with the second optical axis within an entrance pupil of the camera module,
reading in an item of position information which represents a position of the first and of the second and of the third and/or each further optical element detected at a specific time point, and reading in an image signal which represents an item of image information detected by the image sensor at the specified time point, and
associating the position with the image information using the image signal and additionally or alternatively the position information, in order to determine the alignment state of the camera module.

For example, the method can be carried out using a variant of the apparatus presented above, in order to check the adjustment state of the image sensor of a camera with respect to the associated optics. Such a check can be useful, for example, at the end of the manufacturing process of the camera. After completion of the production process, it is necessary to check the quality of the alignment of the camera system. The alignment can be negatively influenced, for example by production steps such as the uneven curing of the adhesive with which the optics and the sensor are fixed to one another, but also by mechanical influences or temperature effects. In order to obtain a quantitative statement about the extent of the sensor tilting or defocussing of the image sensor, in the case of a fully assembled camera system, the method presented here can advantageously be carried out. The aim of the method described here is generally that each position of the optical elements can be directly assigned to the corresponding image signal in a highly accurate manner, i.e. with the smallest possible time offset (latency) and temporal inaccuracy, or that the image information and the associated position of the optical elements can be detected quasi simultaneously. This is necessary in order to be able to determine the position of the highest image contrast with the greatest possible accuracy (in the μm range).

According to one embodiment, the method can have a step of outputting a position trigger signal in order to determine the time point for detecting the position of the first and additionally or alternatively second optical element, it being possible for the position information to be provided in response to the position trigger signal. For example, the illuminated optical elements of the optical devices can be moved continuously from a starting position toward an end position. At the same time, images of the optical elements that follow one another over time can be recorded by the test object by means of the image sensor. The individual image information, which can also be referred to as frames, can be processed for example by an image capture circuit or a frame grabber. This image capture circuit can, for example, output the position trigger signal as soon as an image has been completely recorded. Alternatively, the position trigger signal can be output at the beginning of the image recording. At the same time as the position trigger signal, the image signal, which represents the image information, can be provided, for example, to an evaluation device. The position trigger signal can, for example, be output to a control device for controlling the optical elements. The position of the optical elements existing at this point in time can be provided to the evaluation device, using the position information, in response to the position trigger signal. The image information can thus advantageously be evaluated as a function of the position of the optical elements. In other words, by means of a direct synchronization between the frame grabber and control device, the measuring process can be improved in that on the one hand a continuous focusing run can be traveled at high speed and, on the other hand, no indirect linking between the image position and encoder position takes place via time stamps, which would necessarily require a temporally linear movement process. A position-controlled triggering of the image recording also enables nonlinear (accelerated) movement profiles.

According to a further embodiment, the method can have a step of outputting an image trigger signal in order to determine the time point for detecting the image information, it being possible for the image signal to be provided in response to the image trigger signal. For example, the optical elements can be moved continuously from a starting position to an end position. As soon as an optical element or an encoder of the corresponding optical device has reached a predefined position, the image trigger signal can be output. The image trigger signal can be output, for example, when non-equidistant position marks are reached, for example at the positions 0 mm, 0.1 mm, 0.2 mm, 0.5 mm, 1.0 mm, 2.0 mm and 5.0 mm. For example, the image trigger signal can be output to the image capture circuit at these or other predefined positions in each case. At the same time, the position signal can be provided to the evaluation device. In response to the image trigger signal, the image capture circuit can control the start of an image recording process. The respective image information can then be read out and provided to the evaluation device using the image signal. Each item of image information can be assigned to the predefined position of the optical elements by means of the evaluation device. Alternatively, for example, the image information can be temporarily stored and transmitted at the end of the focusing run and assigned to the positions. An evaluation of the image information as a function of the optical element encoder position can also advantageously be carried out by this step.

According to a further embodiment, the method can comprise a step of storing the image information and additionally or alternatively the position of the first and second optical element. In a first variant, the respective position of the first and second optical elements is stored after it has been detected at a predefined time point in response to a position trigger signal. In this variant, the image information is also stored approximately at the same time as the position trigger signal is output. In a second variant, the image information is stored after it has been detected at a defined time point in response to an image trigger signal. In this variant, the respective position of the first and second optical element is also stored approximately at the same time as the image trigger signal is output.

According to a further embodiment, the first optical element can be moved at a first speed, and the second and/or each further optical element can be moved at a second speed that is different from the first speed. For example, the control device for controlling the optical elements can be designed such that the intermediate images of the optical elements of all optical devices are advantageously located at the same time in the same object plane. In this case, the first optical axis of the first optical device substantially corresponds to an optical axis of the camera module to be checked, and the second and/or further optical device(s) is/are arranged radially at a distance from the first optical device. As a consequence, this means that for example the second optical element of the second optical device should be moved at a different speed from the first optical element. In this case, for example the movement speed of what is known as a master optical device, for example the optical device corresponding to the optical axis of the camera module, can be defined as a guide value to which the speeds of the remaining optical devices can be adjusted accordingly, in terms of control technology. In this case, each individual optical device can comprise its own position encoder, which can be used, for example, in what is known as closed-loop control for the position and speed control. In this case, the signals of the individual optical devices can be electronically transmitted to the control device in parallel. Since the relationship between the positions of the optical elements and apparent object planes (intermediate image planes) is nonlinear, it is furthermore advantageous to travel a corresponding speed profile in order to achieve a uniform measurement point distribution in the image space.

According to a further embodiment, the first and the second speed can have a value of greater than 0 m/s at any time. Additionally or alternatively, the time profile of the first and second and/or further speeds can be able to be described mathematically by a nonlinear function. In this case, a continuous focusing run can advantageously be traveled at high speed, it being possible to omit an indirect linking between image information and position of the optical elements via time stamps, which would necessarily require a temporally linear movement process.

According to a further embodiment, the method can have a step of providing a movement signal, it being possible for the movement signal to represent a specification of the positions to be approached by the optical elements, in particular it being possible for the specification to be stored as a position table. For example, one or more sets of optical element z-positions can be stored in the control unit. The individual z-positions can correspond to different object planes into which the images of the optical elements appear to be projected for the camera module. These apparent object planes are also referred to as intermediate image planes. In this case, the speed profiles of the first optical element and of the second optical element can advantageously be matched to one another in such a way that all images of the optical elements are always located in the predefined object planes at the same time. In this case, for example the transfer of the set of positions in the form of a position table can take place, and the positions can furthermore be equidistant or not equidistant. A trajectory along which the optical elements of the optical devices are moved can thus advantageously be specified.

This method can be implemented, for example, in software or hardware or in a mixed form made up of software and hardware, for example in a control device.

Also advantageous is a computer program product or computer program with program code which can be stored on a machine-readable carrier or storage medium, such as a semiconductor memory, a hard disk memory, or an optical memory, and is used to carry out, implement, and/or control the steps of the method according to one of the embodiments described above, in particular if the program product or program is executed on a computer or an apparatus.

Embodiments of the approach presented here are shown in the figures and explained in more detail in the following description. In the figures:

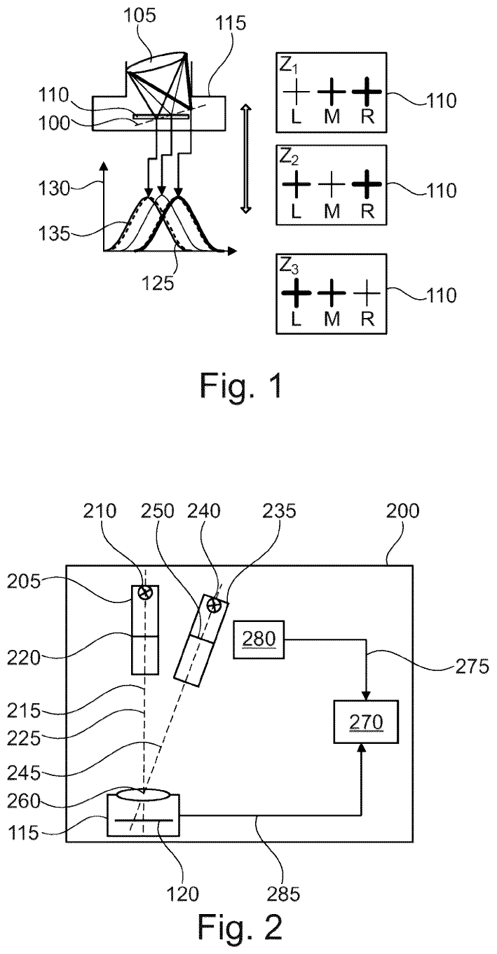

FIG. 1 is a schematic view of an embodiment of a measurement of a tilt between an image plane of an optical unit and a sensor plane;

FIG. 2 is a schematic view of an embodiment of an apparatus;

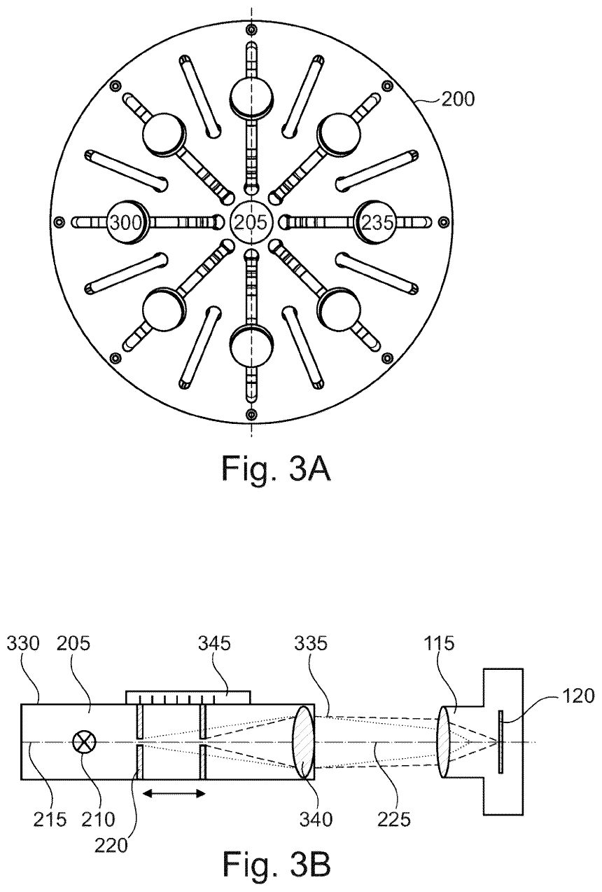

FIG. 3A is a schematic plan view of an embodiment of an apparatus;

FIG. 3B is a schematic cross-sectional view of an embodiment of an apparatus, in side view;

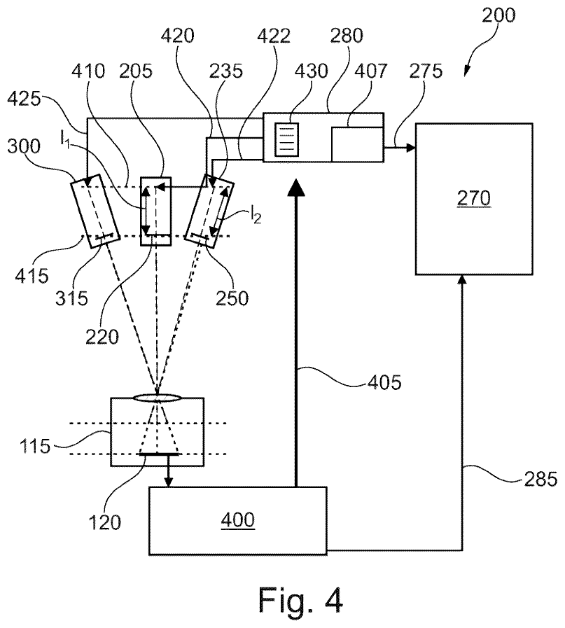

FIG. 4 is a schematic view of an embodiment of an apparatus;

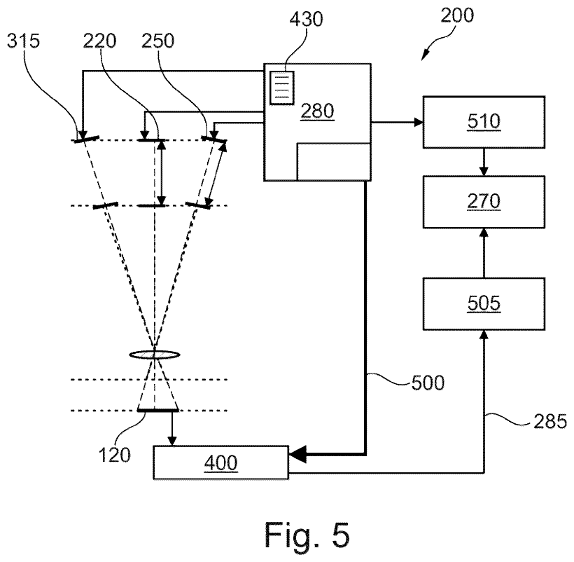

FIG. 5 is a schematic view of an embodiment of an apparatus;

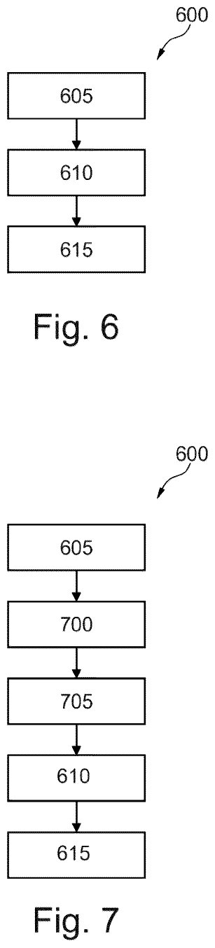

FIG. 6 is a flowchart of an embodiment of a method for checking an adjustment state of an image sensor of a camera module;

FIG. 7 is a flowchart of an embodiment of a method for checking an adjustment state of an image sensor of a camera module; and

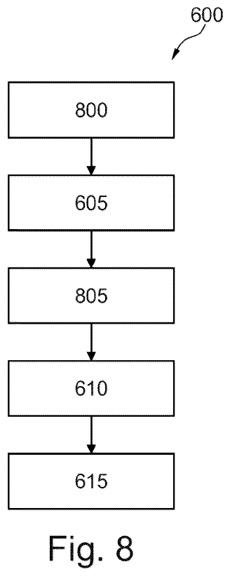

FIG. 8 a flowchart of an embodiment of a method for checking an adjustment state of an image sensor of a camera module.

In the following description of advantageous embodiments of the present invention, the same or similar reference numerals are used for the elements that are shown in various figures and act similarly, whereby a repeated description of these elements is dispensed with.

FIG. 1 is a schematic view of an embodiment of a measurement of a tilt between an image plane 100 of an optical unit 105 and a sensor plane 110. An important measurement parameter during the checking of a camera alignment is the degree of tilting between the image plane 100 of the optics or the optics unit 105 and the sensor plane 110. In the case of the measurement shown here, the camera module 115 to be checked, having optics unit 105 and image sensor 120, can be illuminated with collimated light. The sensor or the optics of the test object can be moved relative to one another, it being possible for an MTF value 130 for a fixed spatial frequency to be determined by way of example at each of the three field positions, at each z-position 125. The result of the measurement, the focusing curve 135 with the contrast values as a function of the z-position is shown on the left-hand, lower side of the image. From the position of the maxima of the three curves along the z-direction, the degree of tilting of the image plane 100 relative to the sensor plane 110 can be concluded, and a defocussing can also be determined. The representation shows this in two dimensions; this evaluation can analogously also take place in three dimensions. In the case of camera systems that are not yet permanently installed, a best focus position can be determined with the aid of an active alignment between the optics and the sensor. After completion of the production process, it is necessary to check the quality of the alignment of the camera system. The alignment can be negatively influenced, for example by production steps such as the uneven curing of the adhesive with which the optics and the sensor are fixed to one another, but also by mechanical influences or temperature effects. In many cases, finished camera modules are checked using simple test image structures, and it is determined whether they fulfill the defined sharpness criteria. However, this method does not offer a quantitative indication of the degree of mechanical tilting or sensor misalignment which has led to an observed drop in sharpness. A systematic optimization of the production process is thereby made more difficult.

FIG. 2 is a schematic view of an embodiment of an apparatus 200. The apparatus 200 is designed to check an adjustment state of an image sensor 120 of a camera module 115. For this purpose, the apparatus 200 comprises a first optical device 205 having a first optical element 220 that can be illuminated by a first light source 210 and can be moved along a first optical axis 215. In this case, the first optical axis 215 in the representation shown here corresponds to an optical axis 225 of the camera module 115 arranged below the first optical device 205 in the image. The apparatus 200 further comprises a second optical device 235 having a second optical element 250 that can be illuminated by a second light source 240 and can be moved along a second optical axis 245. In this case, the second optical device 235 is arranged for example radially (here specifically rotated by an angle relative to the first optical axis 225) at a distance from the first optical device 205, and the first optical axis 215 has an intersection point 260 with the second optical axis 245, the camera module 115 to be checked being arranged in a region of the intersection point 260. In the practical embodiment, further optical devices can also be added correspondingly.

In addition, the apparatus 200 has an evaluation device 270 which is designed to read in a position signal 275. The position signal 275 represents a position of the first and of the second optical element 220, 250 detected at a specific time point, and can be provided to the evaluation device 270, in this embodiment, by a control device 280 for controlling the optical elements 220, 250. The evaluation device 270 is furthermore designed to read in an image signal 285 which represents an item of image information detected by the image sensor 120 at the specific time point. In this case, in this embodiment the evaluation device 270 is designed to assign an item of image information to each detected position using the image signal 285 and the position signal 275, in order to determine the adjustment state of the camera module. In another embodiment, it is also possible for only the position signal or the image signal to be used.

FIG. 3A is a schematic plan view of an embodiment of an apparatus 200. This contains an axial optical device 205 and a plurality of off-axis optical devices 235, 300, which are spaced apart radially, at different angles, from the axial optical device 205. The apparatus 200 shown here corresponds to or resembles the apparatus described in the preceding FIG. 2, with the difference that the apparatus 200 shown here has a third optical device 300 in addition to the first optical device 205 and the second optical device 235. Congruently to the first optical device 205 and the second optical device 235, the third optical device 300 has a third optical element 315 that can be illuminated by a third light source 305 and can be moved along a third optical axis 310. In this case, the third optical device 300 is arranged radially at a distance from the first and second optical device 205, 235, and the third optical axis 310 has an intersection point 260 with the first and second optical axes 215, 245, the camera module 115 to be checked being able to be arranged in a region of the intersection point 260. In the same sense, further optical devices can also be arranged spatially radially around the inlet opening of the camera module to be checked. This situation is illustrated in the plan view in FIG. 3A.

FIG. 3B is a schematic view of an embodiment of a first optical device 205. The first optical device 205 shown here corresponds to or resembles the first optical device described in the preceding FIGS. 2 and 3A, and has a housing 330 in which the first light source 210 is arranged. The first light source 210 is designed to output a light beam 335 which can be collimated by a projection lens 340. In this embodiment, the first optical element 220, which can be moved along the first optical axis 215, is arranged between the first light source 210 and the projection lens 340, the first optical axis 215 corresponding to the optical axis 225 of the camera module 115 to be checked. In this case, the first optical element 220 can be controlled, merely by way of example, by means of a motor drive and a position encoder 345. According to the position of the first optical element 220, the light beam 335 can be modified in such a way that different apparent object distances for the image sensor 120, thus illuminated, of the camera module 115 can be set and, by way of example, different contrast (MTF) values for these object distances can be evaluated. In other words, the optics 340 generates a virtual intermediate image of the optical element 220, which in turn is imaged as an object, by the optics of the system 115 to be tested on its sensor 120.

FIG. 4 is a schematic view of an embodiment of an apparatus 200. The apparatus 200 shown here corresponds to or is similar to the apparatus described in the preceding FIGS. 2 and 3, with the difference that the apparatus 200 in this embodiment comprises an image capture circuit 400. The image capture circuit 400, which can also be referred to as a frame grabber, is designed in this embodiment in order to read out the image sensor 120 depending on the position of the optical elements 220, 250, 315, and to provide the image signal 285 to the evaluation device 270. Merely by way of example, the image capture circuit 400 is additionally designed to output a position trigger signal 405 to the control device 280. In this case, the control device 280 is designed in this embodiment in order to determine the time point for detecting the position of the optical elements 220, 250, 315, in response to the position trigger signal 405, and to store the respective position by means of a memory unit 407, which can also be referred to as an optical element position memory. The positions of the optical elements 220, 250, 315 can then be provided using the position signal 275.

In other words, the apparatus 200 is designed in this embodiment to process the image information captured by the test object, using the image capture circuit 400, the image capture circuit 400 being connected, merely by way of example, to the control device 280 for signal transmission. In this case, in this embodiment all the optical devices 205, 235, 300, more precisely their motor controls, are electronically connected to the control device 280 in parallel. In this embodiment, the control device 280 is designed to store the positions of the optical elements 220, 250, 315 at the specific time point, merely by way of example determined by the position trigger signal 405, which can be the beginning or the end of an image recording. In this case, the optical elements 220, 250, 315 are moved continuously from a starting position 410 to an end position 415. A position of the corresponding intermediate image also correlates with each position of the optical elements. In this case, the optical elements are arranged along their respective optical axes such that all intermediate images lie in a common, apparent object plane. The intermediate images thus also move from a starting position 410 to an end position 415. For the sake of clarity of the image shown here, exclusively the first object plane 410, which corresponds to a starting position of the intermediate images of the optical elements 220, 250, 315, and the second object plane 415, which corresponds to an end position of the intermediate images of the optical elements 220, 250, 315, are imaged. In other embodiments, the intermediate images of the optical elements can be movable along a variable plurality of object planes. For this purpose, in this embodiment a plurality of sets of positions of the optical elements are stored in the control device. The individual positions correspond to different object planes 410, 415, in which the intermediate images of the optical elements 220, 250, 315, which can also be referred to as a reticle, can be arranged. Due to the radial spacing of the optical devices 205, 235, 300 relative to one another, a distance 12 between the starting position and the end position of the second optical element 250 is greater than a distance I₁ between the starting position and the end position of the first optical element 220. In order to compensate for these, the speed profiles of the first optical device 205, the second optical device 235, and the third optical device 300, and also further optical devices, can be matched to one another in such a way that all intermediate images of all optical elements 220, 250, 315 can always be arranged at the same time in the previously defined object planes 410, 415. The control of the optical devices 205, 235, 300 is thus designed such that the intermediate images of the optical elements of all optical devices 205, 235, 300 are located at the same time in the same object plane 410, 415, which has the consequence that the optical elements of the off-axis optical devices 235, 300 are moved at a different speed from the optical elements of the axial optical device 205. In this case, merely by way of example, the movement speed of one of the first optical devices 205 is defined as a guide value to which the speeds of the remaining optical devices 235, 300 are correspondingly matched, in terms of control technology. In this case, each individual one of the optical devices 205, 235, 300 comprises, by way of example, its own position encoder, which can be used in a closed (closed-loop) control for the position and speed control. In this case, the signals of the individual optical devices 205, 235, 300, that is to say the signal of the axial optical device 205 and the signals of the different off-axis optical devices 235, 300, can be electronically transmitted to the control device 280 in parallel. Since the relationship between the optical element position and the apparent object plane is nonlinear, a corresponding speed profile can be traveled, in order to achieve a uniform measurement point distribution in the object space. Merely by way of example, the control device 280 is therefore designed to provide a first movement signal 420, a second movement signal 422, and a third movement signal 425 to the optical devices 205, 235, 300, the movement signals 420, 422, 425 representing a specification for the positions that can be approached by the optical elements 220, 250, 315. For this purpose, merely by way of example a specification for the positions that can be approached by the optical elements 220, 250, 315 is stored in the control device 280 as position table 430.

FIG. 5 is a schematic view of an embodiment of an apparatus 200. The apparatus 200 shown here corresponds to or resembles the apparatus described in the preceding FIGS. 2, 3 and 4, 5, with the difference that, in this embodiment, the control device 280 is designed to output an image trigger signal 500. Merely by way of example, the image trigger signal 500 can be provided to the image capture circuit 400 in order to determine the time point for detecting the image information. Accordingly, the image trigger signal 500 can be triggered, in this embodiment, as soon as the optical elements 220, 250, 315 have reached a predefined position. In this case, the predefined positions to be approached can be stored in a position table 430. The image capture circuit 400 is designed in this embodiment to actuate the image sensor 120 in response to the image trigger signal 500, and to start an image recording process. After capturing the image information, the image signal 285 can be provided. In this case, in this embodiment the image signal 285 can be provided to the evaluation device 270 only indirectly, since, merely by way of example, an image output device 505 is upstream thereof. Likewise, in this embodiment the position signal 275 can be provided to the evaluation device 270 by the control device 280 only indirectly, using a position output device 510.

FIG. 6 is a flowchart of an embodiment of a method 600 for checking an adjustment state of an image sensor of a camera module. The method 600 shown here can be carried out using an apparatus as described in the preceding FIGS. 2, 3, 4 and 5. The method 600 comprises a step 605 of moving a first optical element, that can be illuminated by a first light source, along a first optical axis of a first optical device. In this case, the first optical axis substantially corresponds to an optical axis of the camera module to be checked. In step 605 of movement, a second optical element, that can be illuminated by a second light source, is also moved along a second optical axis of a second optical device. In this case, the second optical device is arranged radially at a distance from the first optical device, and the first optical axis has an intersection point with the second optical axis within the camera module. In this case, merely by way of example the first optical element is only moved at a first speed, and the second optical element is moved at a second speed that is different from the first speed. In this case, in this embodiment both the first and the second speed have a value of greater than 0 m/s at any point in time, and, merely by way of example, the time profile of the first and second speed can be described mathematically by a nonlinear function. Further optical devices can be added to this diagram.

Furthermore, the method 600 comprises a step 610 of reading in. In this step 610, an item of position information is read in, which represents a position of the first and the second optical element detected at a specific time point. In addition, in step 610 of reading in, an image signal is read in which represents an item of image information detected by the image sensor at the specific time point. Step 610 of reading in is followed by a step 615 of assigning the positions to the image information using the image signal and the position information, in order to determine the adjustment state of the camera module.

The aim of the method 600 described here is that each position is assigned the corresponding image signal directly with high accuracy, i.e. with the smallest possible time offset (latency) and temporal inaccuracy, or that the image information and the associated positions of the optical devices are detected quasi simultaneously. This is necessary in order to determine the position of the highest image contrast with the greatest possible accuracy (in the μm range). By means of the method 600 of direct synchronization between the frame grabber and optical device controller, on the one hand it is possible to travel a continuous focusing run at high speed and, on the other hand, there is no indirect linking between image and encoder position via time stamps, which would necessarily require a temporally linear movement process.

FIG. 7 is a flowchart of an embodiment of a method 600 for checking an adjustment state of an image sensor of a camera module. The method 600 set out herein corresponds or to is similar to the method described in the preceding FIG. 6, with the difference that it has additional steps. Thus, in this embodiment, a step 700 of outputting a position trigger signal follows the step 605 of moving. The position trigger signal is output, merely by way of example, in order to determine the time point for detecting the positions of the first and second optical element (and for example) further optical elements. In addition, in this embodiment, the method 600 comprises a step 705 of storing the image information and the positions of the first and second optical elements and all further optical elements. Only thereafter is the position information provided, in this embodiment, in response to the position trigger signal, read in together with the image signal, and a respective position is assigned to each item of image information. In other words, in this embodiment of the method 600, optical elements, in focusable collimators, are moved continuously, i.e. not stepwise, from a starting position to an end position. Meanwhile, recording of temporally successive images of the reticle by the test object and, merely by way of example, processing of the individual items of image information (frames) takes place by a frame grabber. The frame grabber triggers a trigger signal as soon as an image has been completely recorded. In another embodiment, the signal can also be output at the beginning of the image recording. This is followed by storing of the image information and storing of the optical element encoder position information in response to the trigger signal. Subsequently, the image information, for example the contrast values, is evaluated as a function of the optical element encoder position.

FIG. 8 is a flowchart of an embodiment of a method 600 for checking an adjustment state of an image sensor of a camera module. The method 600 set out herein corresponds or to is similar to the method described in the preceding FIGS. 6 and 7, with the difference that it has alternative and additional steps. Merely by way of example, the method 600 comprises a step 800 of providing a movement signal. In this case, the movement signal represents a specification for positions to be approached by the optical elements in step 605 of moving. In this embodiment, this specification is stored as a position table with non-equidistant position marks. In a step 805, an image trigger signal is then triggered in each case, by way of example when the positions 0 mm, 0.1 mm, 0.2 mm, 0.5 mm, 1.0 mm, 2.0 mm and 5.0 mm are reached, in order to determine the time point for detecting the image information, the image signal being provided in response to the image trigger signal. In other words, in this embodiment a continuous movement of the optical elements in the focusable collimators, from a starting position to an end position, takes place. In this case, a trigger signal is triggered as soon as the encoder has reached a predefined position. These trigger signals are, merely by way of example, passed on to the frame grabber, which then starts the image recording process. Subsequently, the image information is read out and stored, associated with the position predefined at the beginning. In another embodiment, the image information can be temporarily stored and transmitted at the end of the focusing run and assigned to the positions. In this embodiment, the image information, for example the contrast values, is evaluated as a function of the optical element encoder position.

1. An apparatus (200) for checking an adjustment state of an image sensor (120) of a camera module (115), the apparatus comprising:
a first optical device (205) having a first optical element (220) that can be illuminated by a first light source (210) and can be moved along a first optical axis (215);
a second optical device (235) having a second optical element (250) that can be illuminated by a second light source (240) and can be moved along a second optical axis (245), wherein the second optical device (235) is arranged at a distance from the first optical device (205), and the first optical axis (215) has an intersection point (260) with the second optical axis (245), wherein the camera module (115) to be checked can be arranged in a region of the intersection point (260); and
an evaluation device (270), which is designed to read in position information (275) which represents a position of the first and the second optical element (220, 250) detected at a specific time point, and to read in an image signal (285) which represents an item of image information detected by the image sensor (120) at the specific time point, wherein the evaluation device (270) is designed to assign an item of image information to each detected position using the image signal (285) and/or the position information (275), in order to determine the adjustment state of the camera module (115).

2. The apparatus (200) according to claim 1, comprising an image capture circuit (400) which is designed to actuate or read out the image sensor (120) depending on the position of the optical elements (220, 250), and which is designed to provide the image signal (285).

3. The apparatus (200) according to claim 1, comprising a control device (280) for controlling the first optical element (220) and the second optical element (250), wherein the control device (280) is designed to provide the position information (275) of the optical devices (205, 235).

4. The apparatus (200) according to claim 1, wherein the apparatus (200) is designed to arrange the first (220) and the second (250) optical element at the specific time point in such a way that the intermediate images of the optical elements (220, 250) are located in an identical object plane (410, 415).

5. The apparatus (200) according to claim 1, comprising a third optical device (300) having a third optical element (315) which can be illuminated by a third light source (305) and can be moved along a third optical axis (310), wherein the third optical device (300) is arranged at a distance from the first and second optical devices (205, 235), and the third optical axis (310) has an intersection point (260) with the first and second optical axes (245), wherein the camera module (115) to be checked can be arranged in a region of the intersection point (260).

6. A method (600) for checking an adjustment state of an image sensor (120) of a camera module (115), the method comprising:
moving (605) a first optical element (220), that can be illuminated by a first light source (210), along a first optical axis (215) of a first optical device (205), wherein the first optical axis (215) substantially corresponds to an optical axis (225) of the camera module (115) to be checked, and moving a second optical element (250), that can be illuminated by a second light source (240), along a second optical axis (245) of a second optical device (235), wherein the second optical device (235) is arranged at a distance from the first optical device (205), and the first optical axis (215) has an intersection point (260) with the second optical axis (245) within the camera module (115);
reading in (610) an item of position information (275) which represents a position of the first optical element (220) and the second optical element (250) detected at a specific time point, and reading in an image signal (285) which represents an item of image information detected by the image sensor (120) at the specific time point; and
assigning (615) the position to the image information using the image signal (285) and/or the position information (275), in order to determine the adjustment state of the camera module (115).

7. The method (600) according to claim 6, comprising a step (700) of outputting a position trigger signal (405) in order to determine the time point for detecting the position of the first and/or second optical element (220, 250), wherein the position information (275) is provided in response to the position trigger signal (405).

8. The method (600) according to claim 6, comprising a step (805) of outputting an image trigger signal (500), in order to determine the time point for detecting the image information, wherein the image signal (285) is provided in response to the image trigger signal (500).

9. The method (600) according to claim 6 comprising a step (705) of storing the image information and/or the position of the first and second optical element (220, 250), wherein the step (705) of storing is carried out before the step (610) of reading in.

10. The method (600) according to claim 6, wherein the first optical element (220) is moved at a first speed and the second optical element (250) is moved at a second speed that is different from the first speed.

11. The method (600) according to claim 10, wherein the first and the second speed have a value greater than 0 m/s at any time point, and/or wherein the time profile of the first and second speeds can be described mathematically by a nonlinear function.

12. The method (600) according to claim 6, comprising a step (800) of providing a movement signal (420), wherein the movement signal (420) represents a specification for positions to be approached by the optical elements (220, 250), in particular wherein the specification is stored as a position table (430).

13. A computer program, which is configured to execute and/or actuate the steps (605, 610, 615) of the method (600) according to claim 6.

14. The machine-readable storage medium, in which the computer program according to claim 13 is stored.
